(19) United States
(12) Patent Application Publication
(10) Pub. No.: US 2026/0145696 A1
(43) Pub. Date: May 28, 2026

(54) ESTABLISHING DRIVERS’ TRUST THROUGH EVENT PREDICTABILITY

(71) Applicant: AUTOBRAINS TECHNOLOGIES LTD, Tel Aviv-Yafo (IL)

(72) Inventors: Igal RAICHELGAUZ, Tel Aviv (IL); Ido COHEN, Tel Aviv-Yafo (IL)

(73) Assignee: AUTOBRAINS TECHNOLOGIES LTD, Tel Aviv-Yafo (IL)

(21) Appl. No.: 18/963,553

(22) Filed: Nov. 28, 2024

(51) Int. Cl. B60W 50/14; B60W 60/00

(52) U.S. Cl. CPC B60W 50/14; B60W 60/001; B60W 2540/00

(57) ABSTRACT

A method for establishing drivers'trust through event predictability, the method includes obtaining, at a machine learning process, path information regarding a driving path of a driving by an autonomous vehicle; identifying, by the machine learning process based on the path information, a road scenario that is accommodated, at least in part, in a path segment of the driving path; determining an artificial intelligence model that is below a maturity threshold with respect to providing a decision making to an autonomous driving in the road scenario, through the path segment of the driving path; and generating instructions executable by a human machine interface to trigger, at a planning of the driving path of the driving, a human visible indication in association with the path segment, the human visible indication reflecting a low maturity artificial intelligence model with respect to the autonomous driving in the path segment.

### BACKGROUND

Human drivers tend to disconnect from driving related tasks when their autonomous vehicles operate in an autonomous driving mode.

Nevertheless-current autonomous vehicles usually require their human drivers to unexpectedly and immediately be involved in the driving of the autonomous vehicle-which deters human drivers from using autonomous driving features.

There is a growing need to overcome this problem.

### SUMMARY

There is provided a method, system and a non-transitory computer readable medium for establishing drivers'trust through event predictability.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a vehicle;

FIG. 2 illustrates an example of a method;

FIG. 3 illustrates an example of a screenshot;

FIG. 4 illustrates an example of indicators;

FIG. 5 illustrates an example of a screenshot;

FIG. 6 illustrates an example of a screenshot; and

FIG. 7 illustrates an example of a method.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

Artificial intelligence is used in relation to machines that mimic human intelligence and human cognitive functions like learning and problem solving. There are three types of artificial intelligence that include artificial super intelligence, artificial narrow intelligence and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example—any reference to a neural network should be applied mutatis mutandis to artificial intelligence and/or should be applied mutatis mutandis to “machine learning”, and/or should be applied mutatis mutandis to “deep learning”.

According to an embodiment a scenario includes at least one of (a) a location of the vehicle, (b) one or more weather conditions, (c) one or more contextual parameters, (d) a road condition, (e) a traffic parameter. Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information-context may be depending on or relating to the circumstances that form the setting for an event, statement, or idea.

According to an embodiment, there is provided a method for establishing drivers'trust through event predictability by giving in advance (and even well in advance) a notification about a road segments that will probably require human driver intervention.

According to an embodiment, there is provided a method for establishing drivers'trust through event predictability, the method includes obtaining, at a machine learning process, path information regarding a driving path of a driving by an autonomous vehicle; identifying, by the machine learning process based on the path information, a road scenario that is accommodated, at least in part, in a path segment of the driving path; determining an artificial intelligence model that is below a maturity threshold with respect to providing a decision making to an autonomous driving in the road scenario, through the path segment of the driving path; and generating instructions executable by a human machine interface to trigger, at a planning of the driving path of the driving, a human visible indication in association with the path segment, the human visible indication reflecting a low maturity artificial intelligence model with respect to the autonomous driving in the path segment.

According to an embodiment, the determining is with respect to a neural network model trained across the road scenario.

According to an embodiment, the determining is with respect to a machine learning decision-based algorithm.

According to an embodiment, the determining is based on the maturity threshold in correspondence with a driving scenario training of the artificial intelligence model.

According to an embodiment, the determining is based on the maturity level in correspondence with a classification metric associated with the artificial intelligence model.

According to an embodiment, the artificial intelligence model is a neural network model trained across the road scenario.

According to an embodiment, the artificial intelligence model is a machine learning decision-based algorithm.

According to an embodiment, machine learning decision-based algorithm is a machine learning process trained to generate decision such as but not limited to driving related decisions.

According to an embodiment, the artificial intelligence model is implemented using a convolution neural network, a You Only Look Once process, a single shot Multibox Detector process, a faster R-CNN process, and the like.

According to an embodiment, the maturity threshold is with respect to a driving scenario training.

According to an embodiment, the maturity level is with respect to a classification metric.

According to an embodiment, the method includes generating instructions executed by the human machine interface to issue a human explainable indication with respect to a need for human-driver intervention during, at least in part, the path segment.

According to an embodiment, the human visible indication is an alert signal.

According to an embodiment, the method includes generating a set of instructions executable by the man machine interface to trigger, at the planning of the driving path, a request to condition the autonomous driving through at least a part of the driving path.

According to an embodiment, the notification is given immediately during the path planning and/or at least a few minutes before the intervention is expected to occur, and/or before the road segment is even sensed by the vehicle or seen by the driver.

According to an embodiment, the method includes suggesting to the human driver an alternative path that does not include the road segment.

According to an embodiment, the method includes altering the path following a feedback from the human driver, after the human driver received the notification.

According to an embodiment, the method includes obtaining, at a machine learning process, path information regarding at least a path to be followed by an autonomous vehicle in a planning of a driving path.

According to an embodiment, the obtaining of the path information is followed by identifying, by the machine learning process, a path segment that is associated with an autonomous driving metric for an autonomous driving through the path segment that is below a threshold.

According to an embodiment, the identifying is followed by generating instructions executable by a man machine interface to trigger, within a time of the planning, a human explainable indication in association with the identified path segment, where the human explainable indication involves a visible indication of the autonomous driving metric being below the threshold.

According to an embodiment, the autonomous driving metric includes a maturity level with respect to an autonomous driving training, and/or autonomous driving limit, and/or classification metric, and the like.

According to an embodiment, the human explainable indication involves an indication of a need for human-driver intervention during the, at least in part, path segment.

According to an embodiment, the human explainable indication is an alert signal.

According to an embodiment, the human explainable indication is a visualization indication.

According to an embodiment, the method also includes generating a set of instructions executable by the man machine interface to trigger, within the time of the planning, a request to condition the autonomous driving through at least a part of the driving path.

According to an embodiment, the method also includes receiving a request to bypass the path segment, and amending the path information to describe an amended path that does not include the path segment.

According to an embodiment, the method also includes generating additional instructions executable by the man machine interface to trigger, within the time of the planning, an additional human explainable indication in association with an alternative path that does not include the path segment.

According to an embodiment, the method also includes generating one or more instructions for generating human perceivable reminders to be triggered at one or more defined time differences from reaching the paths segments.

According to an embodiment, there is provided a non-transitory computer readable medium for establishing drivers'trust through event predictability, that stores instructions executable by at least one processing device to: obtain, at a machine learning process, path information regarding at least a path to be followed by an autonomous vehicle in a planning of a driving path; identify, by the machine learning process, a path segment that is associated with an autonomous driving metric for an autonomous driving through the path segment that is below a threshold; and generate instructions executable by a man machine interface to trigger, within a time of the planning, a human explainable indication in association with the identified path segment. Such that the human explainable indication involves a visible indication of the autonomous driving metric being below the threshold.

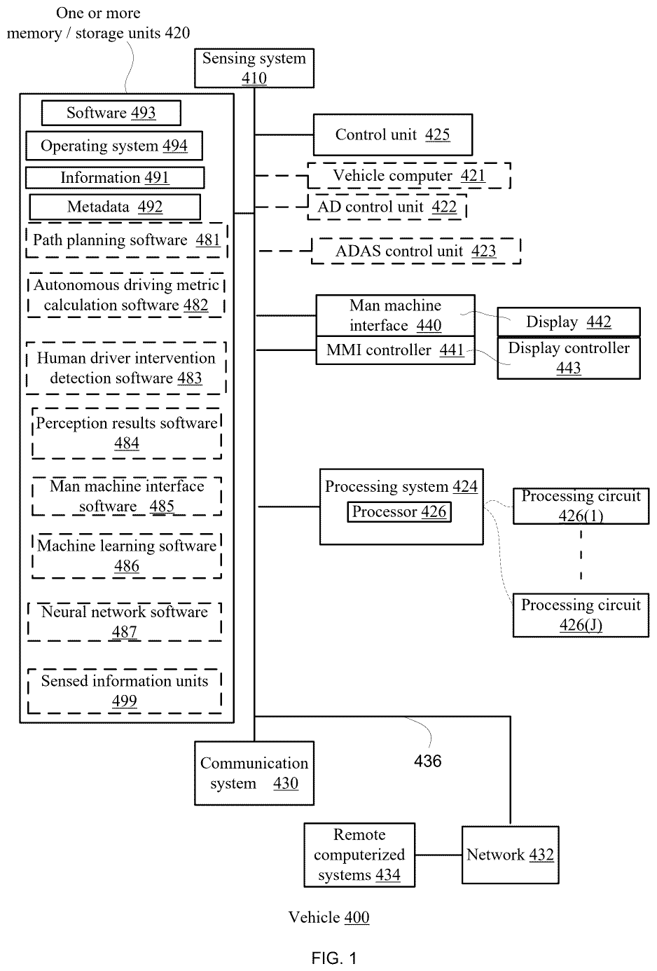

FIG. 1 illustrates an example of a vehicle 400.

Vehicle 400 includes a man machine interface 440 having or being in communication with man machine interface (MMI) controller 441 wherein in FIG. 1 the MMI is a display 442 or includes a display 444 and the MMI controller is a display controller 443 of includes the display controller 443, a communication system 430, one or more memory and/or storage units 420, a processing system 424 including processor 426. The communication system 430, the one or more memory and/or storage units 420, and the processing system 424 may belong to a computerized system of vehicle 400. The computerized system may be a server, a laptop, a desktop or any other computer and may include or be in communication with a sensing unit and/or a controller.

According to an embodiment, vehicle 400 is in communication with network 432 and one or more other remote computerized systems 434 that are in communication with network 432. An example of a remote computerized system is a server or one or more computers having access to a storage system that stores items related to one or more portions of one or more groups of neural networks-at least some of which are not currently stored in the vehicle.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as sensing system 410, man machine interface 440, control unit 425, vehicle computer 421, autonomous driving control unit 422 (denoted AD control unit), advanced driver assistance system (ADAS) control unit 423 (denoted ADAS control unit), and the like.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of memory and/or storage units.

According to an embodiment, the at least one memory unit stores at least one database—such as any database known in the art—such as DB2@, Microsoft® Access, Microsoft® SQL Server, Oracle®, mySQL, PostgreSQL, and the like.

The memory and/or storage units 420 are configured to store firmware and/or software, one or more operating systems, data and metadata required for the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the vehicle. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 494, information 491 such as sensed information units 499, metadata 492, and software 493. Examples of software include path planning software 481, autonomous driving metric calculation software 482, human driver intervention detection software 483, human explainable information software 484, man machine interface software 485, machine learning software 486, and neural network software 487.

FIG. 1 also illustrates information such as sensed information units 499.

The control unit 425 may cooperate with ADAS control unit 423 and/or with AD control unit 422 and/or may control or communicate with other vehicle components—including vehicle computer.

The ADAS control unit 423 is configured to control ADAS operations.

The AD control unit 422 is configured to control autonomous driving of the autonomous vehicle.

The vehicle computer 421 is configured to control the operation of the vehicle—especially controlling the engine, the transmission, and any other vehicle system or component.

The vehicle computer 421 may be in communication with an engine control module, a transmission control module, a powertrain control module, and the like.

The sensing system 410 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 410 is configured to output one or more sensed information units (SIUs).

Control unit 425 is configured to control the operation of the sensing system 410, and/or the one or more memory and/or storage units 420 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 is configured to perform, while executing software:
Obtain, at a machine learning process, path information regarding at least a path to be followed by an autonomous vehicle in a planning of a driving path.
Identify, by the machine learning process, a path segment that is associated with an autonomous driving metric for an autonomous driving through the path segment that is below a threshold.
Generate instructions executable by a man machine interface to trigger, within a time of the planning, a human explainable indication in association with the identified path segment, where the human explainable indication involves a visible indication of the autonomous driving metric being below the threshold.

According to an embodiment the processing system 424 is also configured to perform, while executing additional software at least one of:
Generate a set of instructions executable by the man machine interface to trigger, within the time of the planning, a request to condition the autonomous driving through at least a part of the driving path.
Receive a request to bypass the path segment, and amend the path information to describe an amended path that does not include the path segment.
Generate additional instructions executable by the man machine interface to trigger, within the time of the planning, an additional human explainable indication in association with an alternative path that does not include the path segment.

Any method illustrated in the application is executable by a processor and/or at least one processing device, or processing circuit (also referred to as a processing circuitry)—an example of which is illustrated in FIG. 1.

According to an embodiment, processing system 424 is configured to perform, while executing software:
Obtain, at a machine learning process, path information regarding a driving path of a driving by an autonomous vehicle.
Identify, by the machine learning process based on the path information, a road scenario that is accommodated, at least in part, in a path segment of the driving path.
Determine an artificial intelligence model that is below a maturity threshold with respect to providing a decision making to an autonomous driving in the road scenario, through the path segment of the driving path.
Generate instructions executable by a human machine interface to trigger, at a planning of the driving path of the driving, a human visible indication in association with the path segment, the human visible indication reflecting a low maturity artificial intelligence model with respect to the autonomous driving in the path segment.

According to an embodiment the processing system 424 is also configured to perform, while executing additional software at least one of:
Generate instructions executed by the human machine interface to issue a human explainable indication with respect to a need for human-driver intervention during, at least in part, the path segment.
Generate a set of instructions executable by the man machine interface to trigger, at the planning of the driving path, a request to condition the autonomous driving through at least a part of the driving path.

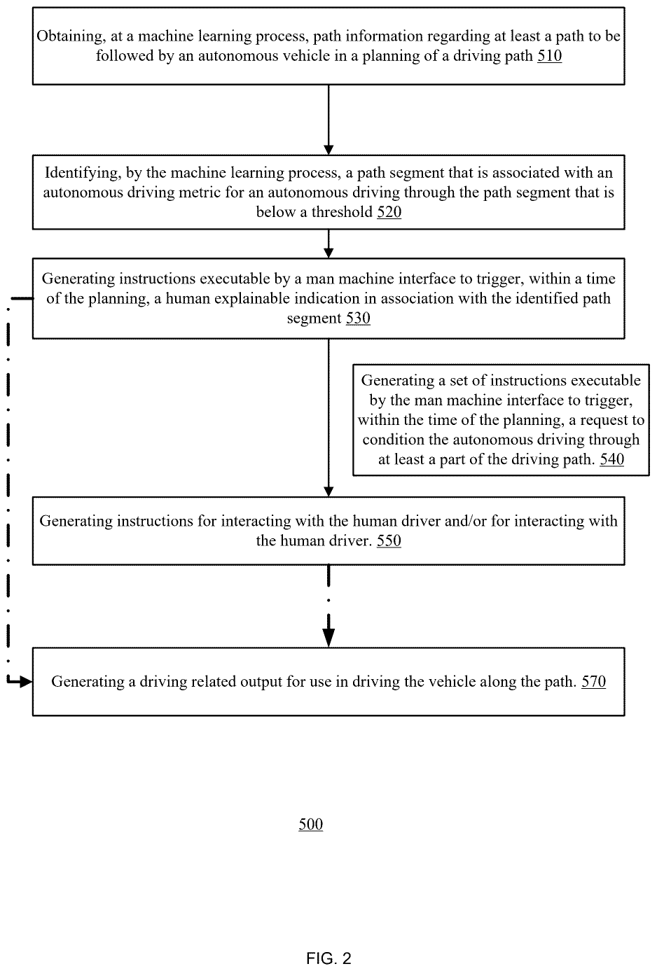

FIG. 2 illustrates an example of method 500 for establishing drivers'trust through event predictability.

According to an embodiment, the method includes step 510 of obtaining, at a machine learning process, path information regarding at least a path to be followed by an autonomous vehicle in a planning of a driving path.

The path information may be generated by the machine learning process or be received by the machine learning process and generated by another entity—either a vehicle associated entity or another entity such as a cloud computing software, or any other software executed by an out of vehicle computerized system.

According to an embodiment, the path information is generated based on input of the human driver—for example the destination of the driver.

Accordingly, the path is dictated to the human driver—for example a path dictated by an employer of the human driver—for example a path dictated by a delivery operator, and the like.

According to an embodiment, the path starts at the expected or actual location of the vehicle—or at any another location.

According to an embodiment, step 510 is followed by step 520 of identifying, by the machine learning process, an artificial intelligence model that is below a maturity level for a particular path segment in the designated driving path of the vehicle. In an example, the artificial intelligence model may be below a maturity level with respect to an autonomous driving metric for an autonomous driving through the path segment. The autonomous driving metric can include an autonomous driving speed limit, autonomous driving rule, and/or any other attribute, configurational or operational metric affecting or that is part of any level of autonomous-based driving.

In another embodiment, the autonomous driving metric is within a maturity level with respect to an autonomous driving training, such as a classification metric or a perception metric. For example, the maturity level is indicative of the amount and/or quality of data used to train one or more autonomous driving skills in relation to driving over path segments of the type of the path segment identified during step 520.

Assuming that the path segment presents a given artificial intelligence model—then according to an embodiment, there may be a threshold of the amount of data that (of at least a defined quality level) must be surpassed in relation to an artificial intelligence model determined as mature before autonomous driving in the path associated with the artificial intelligence model.

According to an embodiment, the amount of data required may be determined by the one of the autonomous vehicle manufacturer, by insurance companies, by autonomous driving software vendors, by laws and/or regulations, by a technical standard, and the like.

According to an embodiment, the amount of data required may be determined by the number of false detections or a ratio between false detection and accurate detections.

According to an embodiment, the autonomous driving capability of an autonomous vehicle is not limitless and is it associated with limitations-especially scenes that are not regarded as safe for autonomous driving—for example based on the complexity of arriving, danger associated with the driving, illumination and/or weather conditions—and the like.

According to an embodiment, an artificial intelligence model is associated with one or more road elements that are classified with a classification certainty below classification threshold—and the autonomous driving metric reflects the classification certainty. For example—when well defined classes are associated with corresponding signature clusters—then the distance of a signature associated with the road elements to one or more cluster centroids may provide an indication of the classification certainty of the artificial intelligence model.

According to an embodiment the classification certainty is indicative of the repeatability of classification decisions of an artificial intelligence model with respect to a particular path segment.

According to an embodiment, step 520 is followed by step 530 of generating instructions executable by a man machine interface to trigger, within a time of the planning, a human explainable indication in association with the determined artificial intelligence model with respect to the path segment, where the human explainable indication involves a visible indication of the autonomous driving metric being below the threshold.

According to an embodiment, the human explainable indication involves an indication of a need for human-driver intervention during the, at least in part, corresponding path segment.

According to an embodiment, the human explainable indication is an alert signal. The alert signal may be visual, audio or audio-visual.

According to an embodiment, the human explainable indication is a visualization indication that provides explanations about the artificial intelligence model, and/or corresponding path segment, and/or of the reason for identifying the artificial intelligence model, and/or corresponding path segment, as requiring human driver involvement.

According to an embodiment, method 500 includes step 540 of generating a set of instructions executable by the man machine interface to trigger, within the time of the planning, a request to condition the autonomous driving through at least a part of the driving path associated with artificial intelligence models below a maturity level.

According to an embodiment, step 530 is followed by step 550 of generating instructions for interacting with the human driver and/or for interacting with the human driver.

According to an embodiment, step 550 includes at least one of:
Receiving a request to bypass the path segment.
Amending the path information to describe an amended path that does not include artificial intelligence models below a maturity level.
Generating instructions for amending the path information path that does not include the artificial intelligence models below a maturity level.
Generating an additional human explainable indication in association with an alternative path that does not include the artificial intelligence models below a maturity level.

According to an invention, once the path planning is completed, method 500 includes step 570 of generating a driving related output for use in driving the vehicle along the path.

According to an embodiment, the driving related output includes at least one of:
An instruction and/or a request executable by an autonomous control unit of the vehicle to follow the path.
An instruction and/or a request executable by an autonomous control unit of the vehicle to perform an autonomous driving related operation associated with the artificial intelligence models below a maturity level along the path, such as autonomously changing a speed of the vehicle, autonomously changing an acceleration of the vehicle, autonomously changing an acceleration of the vehicle, autonomously changing a mode of operation of the vehicle.
An instruction and/or a request executable by a computer vehicle in association with following the path and related to a manner of operation of any component of the vehicle, such as brakes, engine, and the like.

According to an embodiment, the method includes outputting and/or transmitting an/or storing and/or instructing to respond to and/or triggering a response to and/or controlling a response to and/or performing a respond to any of the driving related output listed above and/or below.

According to an embodiment, the method includes generating and/or requesting and/or determining and/or instructing and/or triggering and/or controlling and/or transmitting and/or outputting and/or preforming at least one autonomous or non-autonomous driving related operation is associated with the artificial intelligence models below a maturity level, and/or driving along the path—for example in compliant with one or more levels of autonomous driving—such as L2, L2+, L2++, L3 or L4 autonomous driving.

The providing may include storing at a location accessible to another unit controller, transmitting the instructions to the other unit, sending an indication about the generation of the instructions to the other unit man machine interface controller.

According to an embodiment, the method may include outputting and/or transmitting an/or storing and/or instructing to respond to and/or triggering a response to and/or controlling a response to and/or performing a respond to any of the driving related output listed above and/or below.

According to an embodiment, method 500 is responsive to one or more driver related parameters—such as driving skills, physiological state, and the like.
For example—if the machine learning process is made aware (by sensing or by receiving information) driver is found to have pool driving skills or is stressed or is not fully sober—the method may include amending a path such as not to include artificial intelligence models below a maturity level that may require human intervention.
Yet for another example—the threshold to which the autonomous driving metric is changed according to the driving skills, physiological state-for example may be lowered when the driver has high driving skills and is sober.
Yet for another example—the autonomous driving metric is set in part based on the driving skills and/or the physiological state of the driver.

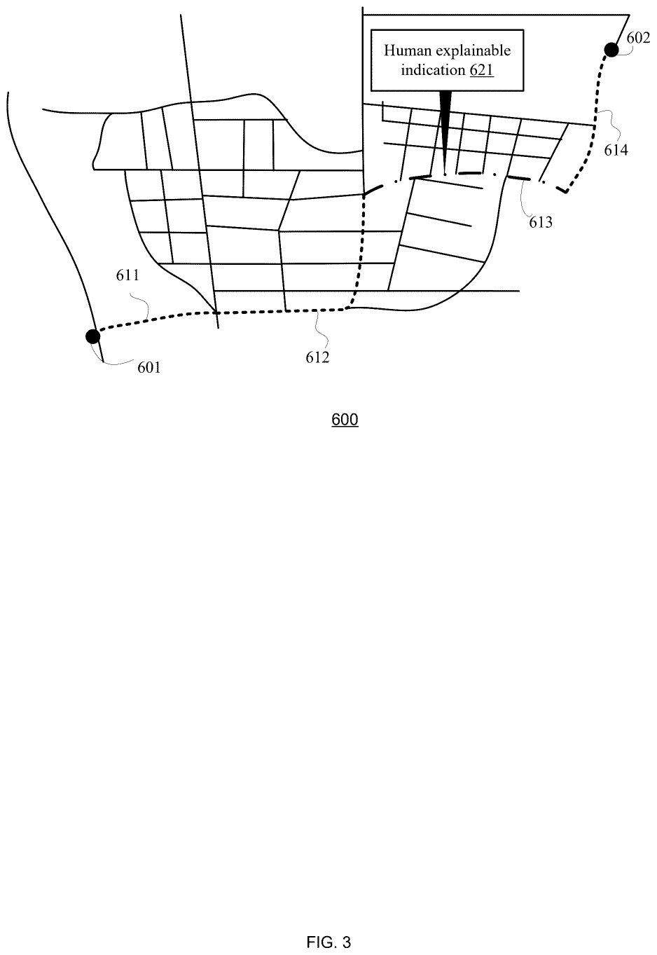

FIG. 3 illustrates an example of a screenshot 600 of a display that illustrated a path map that includes a path having start point 601 and an end point 602, a first path segment 611, a second path segment 612, a third path segment 613 and a fourth path segment 614. The third path segment 613 is identified as being associated with an artificial intelligence model having an autonomous driving metric that is below a threshold an autonomous driving through the path segment.

FIG. 3 illustrates a display of a human explainable indication 621 that is linked to the third path segment 613.

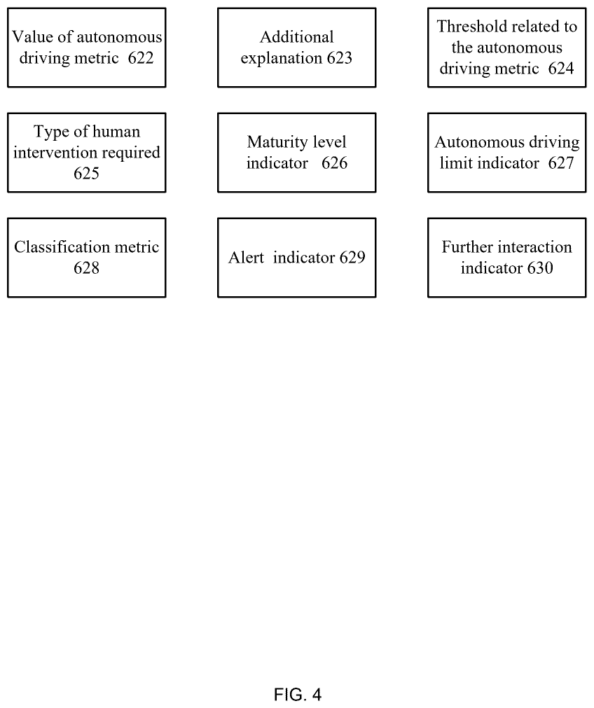

FIG. 4 illustrates example of visual indications that can be associated with an artificial intelligence model having an autonomous driving metric that is below a threshold for autonomous driving through a path segment. These visual indications include at least one of:
Value of autonomous driving metric 622.
Additional explanation regarding the reasons of having the artificial intelligence model identified with respect to path segment 623.
The threshold 624 that is related to the autonomous driving metric.
Type of human intervention required 625 when driving over the path—merely paying attention to the environment of the vehicle, holding the driving wheels, taking partial charge of the driving till taking over the driving.
Maturity level indicator 626.
Autonomous driving limit indictor 627.
Classification metric 628.
Alert indicator 629.
Further interaction indicator 630, such as an invitation to the driver to further interact in order to accept/reject and/or amend the driving through the designated path.

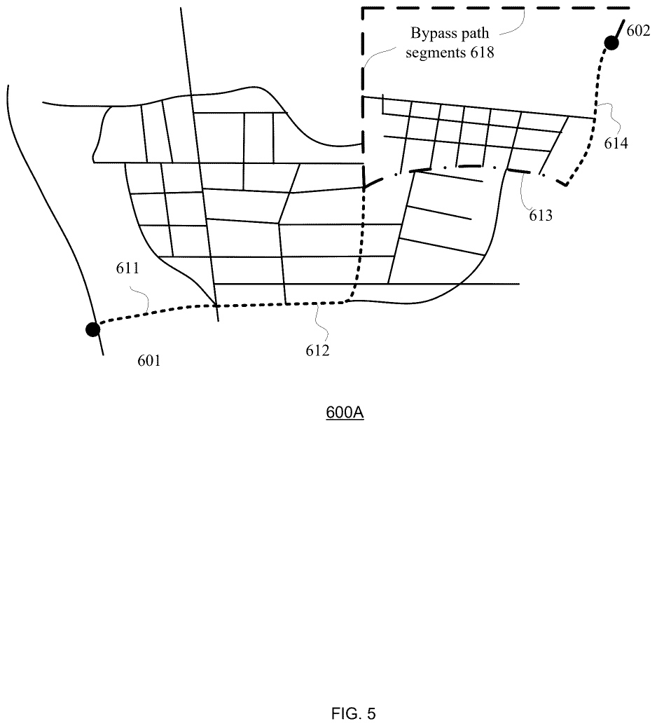

FIG. 5 illustrates a screenshot 600A of a display that also includes a suggested bypass path segments 618 that if chosen will bypass the artificial intelligence models associated with the third path segment 613.

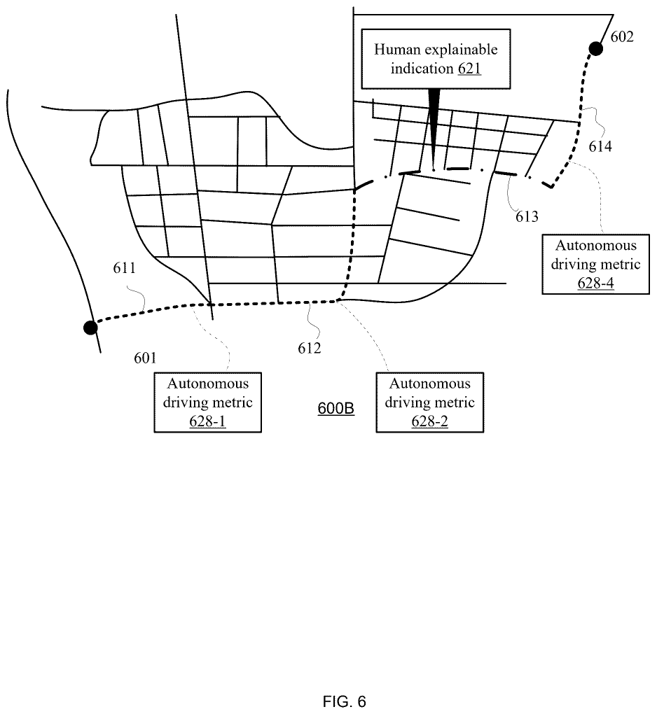

FIG. 6 illustrates a screenshot 600B of a display that also includes indications regarding the value of the autonomous driving metric of the artificial intelligence models associated with the first, second and fourth path segments—628-1, 628-2, 628-4, respectively.

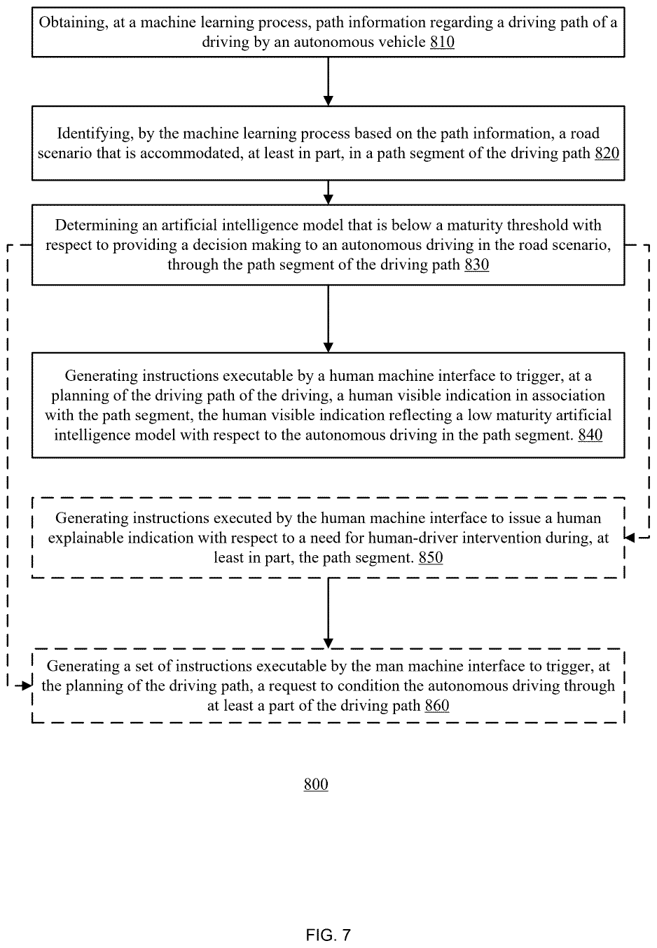

FIG. 7 illustrates an example of method 800 for establishing drivers'trust through event predictability.

According to an embodiment, method 800 includes step 810 of obtaining, at a machine learning process, path information regarding a driving path of a driving by an autonomous vehicle.

The path information is generated by the machine learning process or be received by the machine learning process and generated by another entity—either a vehicle associated entity or another entity such as a cloud computing software, or any other software executed by an out of vehicle computerized system.

According to an embodiment, the path information is generated based on input of the human driver-for example the destination of the driver.

Accordingly, the path is dictated to the human driver—for example be a path dictated by an employer of the human driver—for example a path dictated by a delivery operator, and the like.

According to an embodiment the path starts at the expected or actual location of the vehicle—or at another location.

According to an embodiment, step 810 is followed by step 820 of identifying, by the machine learning process based on the path information, a road scenario that is accommodated, at least in part, in a path segment of the driving path.

According to an embodiment, the identifying of the road scenario is based on road scenarios identified by one or more vehicles that passes through the road segment. According to an embodiment, the identifying of the road scenario is generated based on a previous generate association between the road segment and the road scenario. According to an embodiment, the association is executed by a computerized system that received environmental information from multiple vehicles that drove through the road segment and analyzes the received environmental information to determine a scenario.

According to an embodiment, step 820 is followed by step 830 of determining an artificial intelligence model that is below a maturity threshold with respect to providing a decision making to an autonomous driving in the road scenario, through the path segment of the driving path.

According to an embodiment, the maturity level is indicative of the amount and/or quality of data used to train one or more autonomous driving skills in relation to driving over path segments of the type of the path segment identified during step 520.

Assuming that the path segment presents a given scenario—then according to an embodiment, there may be a threshold of the amount of data that (of at least a defined quality level) must be surpassed in relation to a scenario before autonomous driving at the presence of the scenario can be defined as mature.

According to an embodiment, the amount of data required may be determined by the one of the autonomous vehicle manufacturer, by insurance companies, by autonomous driving software vendors, by laws and/or regulations, by a technical standard, and the like.

According to an embodiment, the amount of data required may be determined by the number of false detections or a ratio between false detection and accurate detections.

According to an embodiment, the autonomous driving capability of an autonomous vehicle is not limitless and is it associated with limitations—especially scenes that are not regarded as safe for autonomous driving—for example based on the complexity of arriving, danger associated with the driving, illumination and/or weather conditions—and the like.

According to an embodiment, step 830 is followed by at least one step of steps 840, 850 or 860.

According to an embodiment, step 840 includes generating instructions executable by a human machine interface to trigger, at a planning of the driving path of the driving, a human visible indication in association with the path segment, the human visible indication reflecting a low maturity artificial intelligence model with respect to the autonomous driving in the path segment.

According to an embodiment, step 850 includes generating instructions executed by the human machine interface to issue a human explainable indication with respect to a need for human-driver intervention during, at least in part, the path segment.

According to an embodiment, the human visible indication is an alert signal.

According to an embodiment, step 860 includes generating a set of instructions executable by the man machine interface to trigger, at the planning of the driving path, a request to condition the autonomous driving through at least a part of the driving path.

According to an embodiment, the artificial intelligence model is a neural network model trained across the road scenario.

According to an embodiment, the artificial intelligence model is a machine learning decision-based algorithm.

According to an embodiment, the maturity threshold is with respect to a driving scenario training.

According to an embodiment, the maturity level is with respect to a classification metric.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove.

Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

1. A method for establishing drivers'trust through event predictability, the method comprises:
obtaining, at a machine learning process, path information regarding a driving path of a driving by an autonomous vehicle;
identifying, by the machine learning process based on the path information, a road scenario that is accommodated, at least in part, in a path segment of the driving path;
determining an artificial intelligence model that is below a maturity threshold with respect to providing a decision making to an autonomous driving in the road scenario, through the path segment of the driving path; and
generating instructions executable by a human machine interface to trigger, at a planning of the driving path of the driving, a human visible indication in association with the path segment, the human visible indication reflecting a low maturity artificial intelligence model with respect to the autonomous driving in the path segment.

2. The method according to claim 1, wherein the determining is with respect to a neural network model trained across the road scenario.

3. The method according to claim 1, wherein the determining is with respect to a machine learning decision-based algorithm.

4. The method according to claim 1, wherein the determining is based on the maturity threshold in correspondence with a driving scenario training of the artificial intelligence model.

5. The method according to claim 1, wherein the determining is based on the maturity level in correspondence with a classification metric associated with the artificial intelligence model.

6. The method according to claim 1, further comprising generating instructions executed by the human machine interface to issue a human explainable indication with respect to a need for human-driver intervention during, at least in part, the path segment.

7. The method according to claim 1, wherein the generating the instructions triggers the human visible indication as an alert signal.

8. The method according to claim 1, further comprising generating a set of instructions executable by the man machine interface to trigger, at the planning of the driving path, a request to condition the autonomous driving through at least a part of the driving path.

9. A non-transitory computer readable medium for establishing drivers'trust through event predictability, that stores instructions executable by at least one processing device to:
obtain, at a machine learning process, path information regarding a driving path of a driving by an autonomous vehicle;
identify, by the machine learning process based on the path information, a road scenario that is accommodated, at least in part, in a path segment of the driving path;
determine an artificial intelligence model that is below a maturity threshold with respect to providing a decision making to an autonomous driving in the road scenario, through the path segment of the driving path; and
generate instructions executable by a human machine interface to trigger, at a planning of the driving path of the driving, a human visible indication in association with the path segment, the human visible indication reflecting a low maturity artificial intelligence model with respect to the autonomous driving in the path segment.

10. The non-transitory computer readable medium according to claim 9, wherein the artificial intelligence model is a neural network model trained across the road scenario.

11. The non-transitory computer readable medium according to claim 9, wherein the artificial intelligence model is a machine learning decision-based algorithm.

12. The non-transitory computer readable medium according to claim 9, wherein the maturity threshold being in correspondence with a driving scenario training of the artificial intelligence model.

13. The non-transitory computer readable medium according to claim 9, wherein the maturity level being in correspondence with a classification metric associated with the artificial intelligence model.

14. The non-transitory computer readable medium according to claim 9, that further stores instructions executable by the at least one processing device to generate instructions executed by the human machine interface to issue a human explainable indication with respect to a need for human-driver intervention during, at least in part, the path segment.

15. The non-transitory computer readable medium according to claim 9, wherein the human visible indication is an alert signal.

16. The non-transitory computer readable medium according to claim 9, that further stores instructions executable by the at least one processing device to generate a set of instructions executable by the human machine interface to trigger, at the planning of the driving path, a request to condition the autonomous driving through at least a part of the driving path.

17. A system of establishing drivers'trust through event predictability, the system comprising:
at least one processing device configured to.
obtain, at a machine learning process, path information regarding a driving path of a driving by an autonomous vehicle;
identify, by the machine learning process based on the path information, a road scenario that is accommodated, at least in part, in a path segment of the driving path;
determine an artificial intelligence model that is below a maturity threshold with respect to providing a decision making to an autonomous driving in the road scenario, through the path segment of the driving path; and
generate instructions executable by a human machine interface to trigger, at a planning of the driving path of the driving, a human visible indication in association with the path segment, the human visible indication reflecting a low maturity artificial intelligence model with respect to the autonomous driving in the path segment.
